(19) United States
(12) Patent Application Publication
(10) Pub. No.: US 2020/0372306 A1
(43) Pub. Date: Nov. 26, 2020

(54) UTILIZING A MACHINE LEARNING MODEL TO AUTOMATICALLY CORRECT REJECTED DATA

(71) Applicant: Accenture Global Solutions Limited, Dublin (IE)

(72) Inventors: Ashok NAYAK, Irving, TX (US); Sreenanda GHOSH, Kolkata (IN); Souvik SINHA, Kolkata (IN); Shrestha DEY, Kolkata (IN)

(21) Appl. No.: 16/417,923

(22) Filed: May 21, 2019

(51) Int. Cl. G06K 9/62; G06N 20/00; G06N 5/02

(52) U.S. Cl. CPC G06K 9/6263; G06N 5/025; G06N 20/00; G06K 9/6256

(57) ABSTRACT

A device receives data from data sources. The device may reject a portion of the data as rejected data, and may accept a remaining portion of the data as accepted data. The device may process the rejected data, with a machine learning model, to correct the rejected data and to generate corrected data, and may determine whether the corrected data satisfies a threshold. The device may provide the corrected data to a client device when the corrected data fails to satisfy the threshold, and may receive, from the client device, feedback on the corrected data provided to the client device. The device may modify the corrected data, based on the feedback, to generate modified data, and may store the accepted data and the modified data in a data structure. The device updates the machine learning model, based on the modified data, to handle the rejected data at a later time.

### BACKGROUND

Master data management (MDM) may define and manage data of an organization to provide, with data integration, a single point of reference. The data may include reference data (e.g., a set of permissible values), analytical data that supports decision making, and/or the like. Master data management may include removing duplicates from data, standardizing data, incorporating rules to eliminate incorrect data, and/or the like to create an authoritative source of master data. Master data management may include collecting, aggregating, matching, consolidating, quality-assuring, persisting, distributing, and/or the like data throughout an organization to ensure a common understanding, consistency, accuracy, and control in the ongoing maintenance and use of the data.

### SUMMARY

According to some implementations, a method may include receiving data from one or more data sources, and rejecting a portion of the data as rejected data. The method may include accepting another portion of the data as accepted data, and processing the rejected data, with a machine learning model, to correct the rejected data and to generate corrected data. The method may include determining whether the corrected data satisfies a threshold, and providing the corrected data to a client device associated with a user when the corrected data fails to satisfy the threshold. The method may include receiving, from the client device, user feedback on the corrected data provided to the client device, and modifying the corrected data, based on the user feedback, to generate modified data. The method may include storing the accepted data and the modified data in a data structure associated with the device.

According to some implementations, a device may include one or more memories, and one or more processors, communicatively coupled to the one or more memories, to receive data from one or more data sources, and reject a portion of the data as rejected data. The one or more processors may accept a remaining portion of the data as accepted data, and may process the rejected data, with a machine learning model, to correct the rejected data and to generate corrected data, wherein the machine learning model is trained with historical rejected data, and wherein the historical rejected data is received prior to receipt of the data from the one or more data sources. The one or more processors may determine whether the corrected data satisfies a threshold, and may provide the corrected data to a client device associated with a user when the corrected data fails to satisfy the threshold. The one or more processors may receive, from the client device, user feedback on the corrected data provided to the client device, and may modify the corrected data, based on the user feedback, to generate modified data. The one or more processors may store the accepted data and the modified data in a data structure associated with the device, and may update the machine learning model, based on the modified data, to handle the rejected data at a later time.

According to some implementations, a non-transitory computer-readable medium may store one or more instructions that, when executed by one or more processors of a device, may cause the one or more processors to receive data from one or more data sources, and determine whether the data is to be rejected or accepted, wherein a portion of the data is determined to be rejected data, and wherein a remaining portion of the data is determined to be accepted data. The one or more instructions may cause the one or more processors to process the rejected data, with a machine learning model, to correct the rejected data and to generate corrected data, and provide the corrected data to a client device associated with a user. The one or more instructions may cause the one or more processors to receive, from the client device, user feedback on the corrected data provided to the client device, and modify the corrected data, based on the user feedback, to generate modified data. The one or more instructions may cause the one or more processors to store the accepted data and the modified data in a data structure associated with the device, and update the machine learning model, based on the modified data, to handle the rejected data at a later time.

### BRIEF DESCRIPTION OF THE DRAWINGS

FIGS. 1A-1I are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for utilizing a machine learning model to automatically correct rejected data.

### DETAILED DESCRIPTION

The following detailed description of example implementations refers to the accompanying drawings. The same reference numbers in different drawings may identify the same or similar elements.

One issue with master data management is the waste of computing resources (e.g., processing resources, memory resources, and/or the like), network resources, manual resources (e.g., data entry personnel, data managers, and/or the like) associated with rejected data (e.g., data that is rejected due to being unrecognized, unstructured, improperly formatted, from different data source forms of input, incorrectly entered, and/or the like). A user (e.g., a data manager) must utilize the computing resources, the network resources, and/or the like over and over again to correct the same or similar rejected data.

Some implementations described herein provide a management platform that utilizes a machine learning model to automatically correct rejected data. For example, the management platform may receive data from one or more data sources, and may reject a portion of the data as rejected data. The management platform may accept a remaining portion of the data as accepted data, and may process the rejected data, with a machine learning model, to correct the rejected data and to generate corrected data. The management platform may determine whether the corrected data satisfies a threshold, and may provide the corrected data to a client device associated with a user when the corrected data fails to satisfy the threshold. The management platform may receive, from the client device, user feedback on the corrected data provided to the client device, and may modify the corrected data, based on the user feedback, to generate modified data. The management platform may store the accepted data and the modified data in a data structure associated with the device, and may update the machine learning model, based on the modified data, to handle the rejected data at a later time.

In this way, the management platform identifies and corrects rejected data without further interaction from the user, which conserves resources (e.g., computing resources, network resources, manual resources, and/or the like) that would otherwise be wasted in repeatedly investigating, determining, and correcting the same rejected data. The management platform also conserves such resources by reducing errors associated with correcting rejected data, improving data quality accuracy associated with the rejected data, delivering the rejected data more quickly for an entity, eliminating a need for a system development life cycle (SDLC) and an exchange to exchange (E2E) development cycle, eliminating validation of business rules, eliminating data conversion, and/or the like.

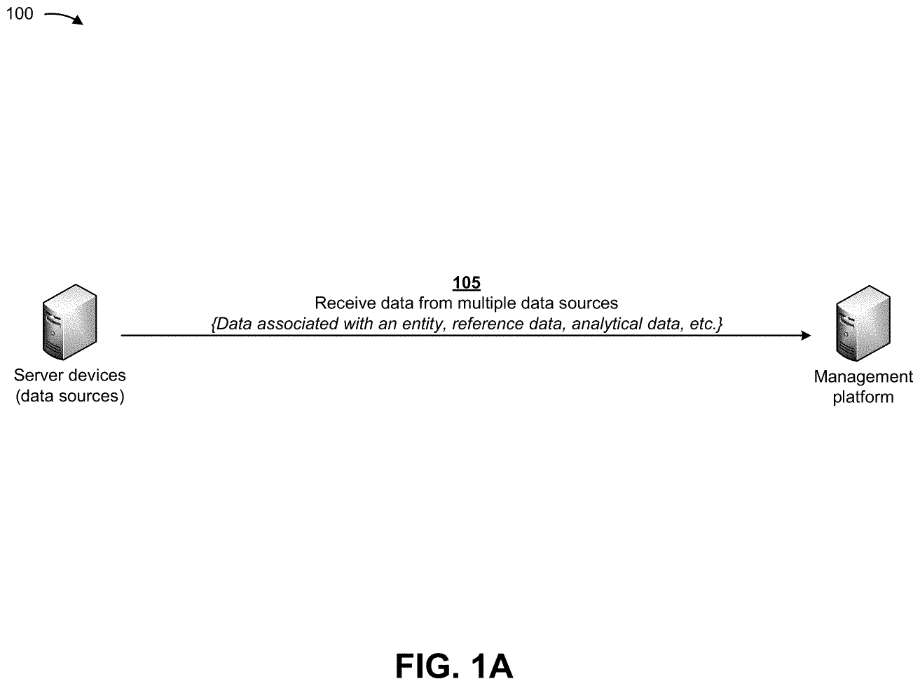

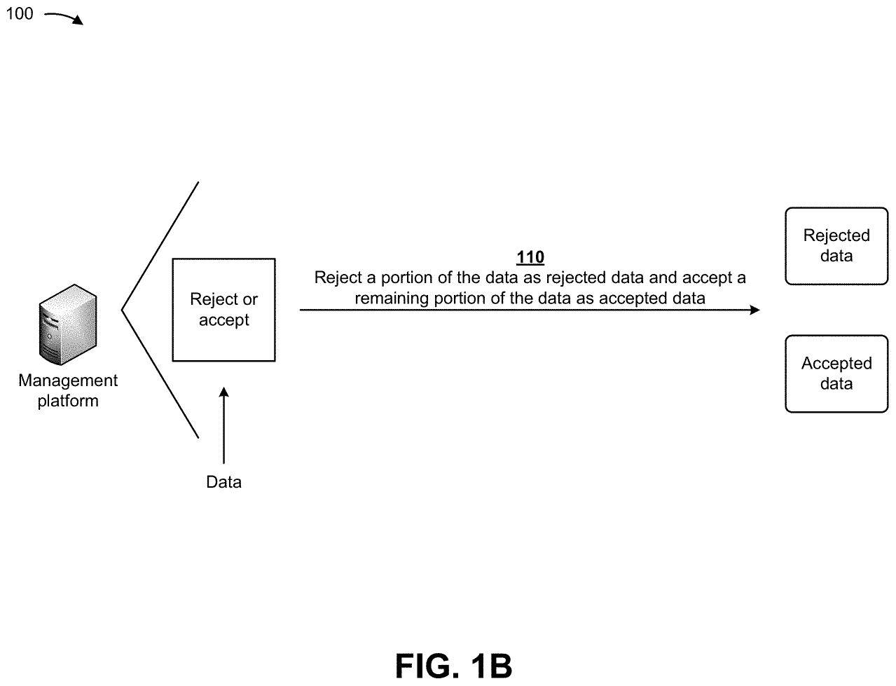

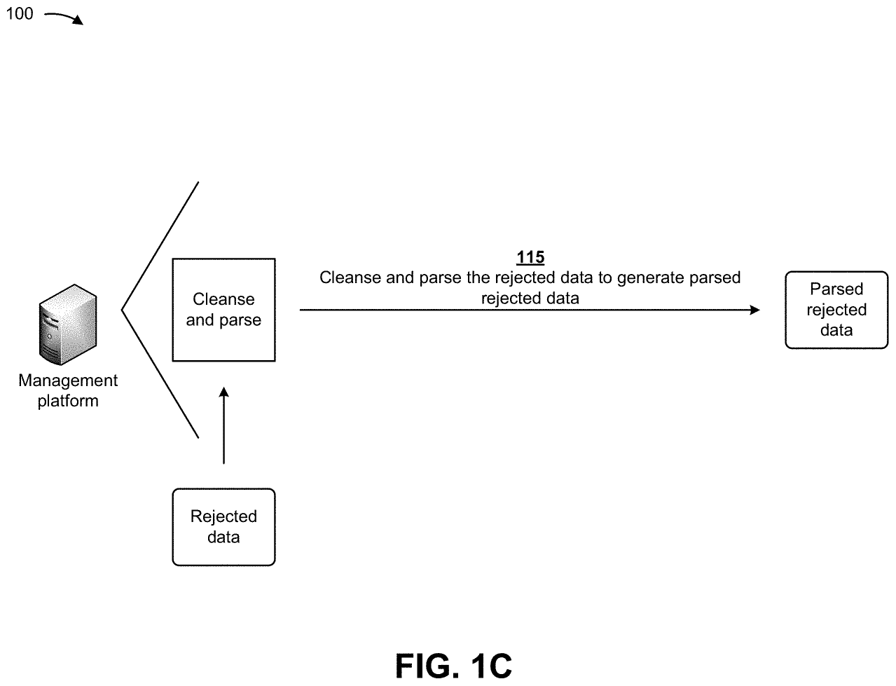

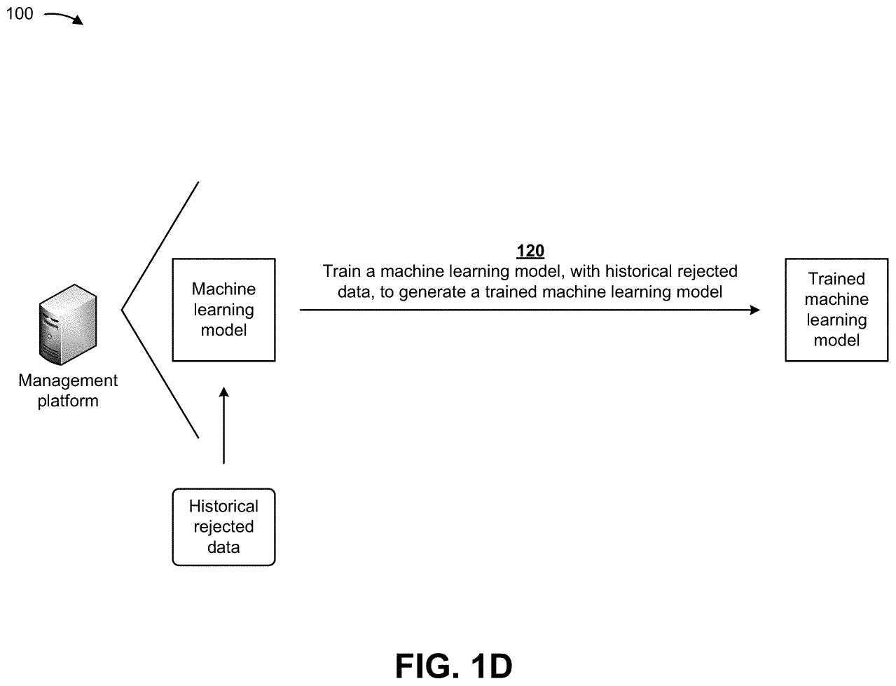

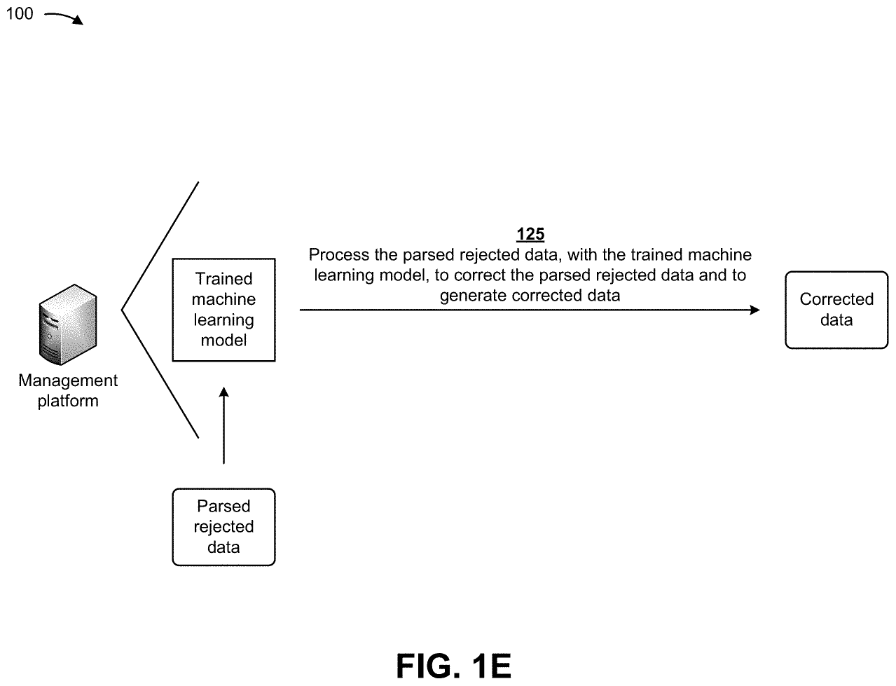

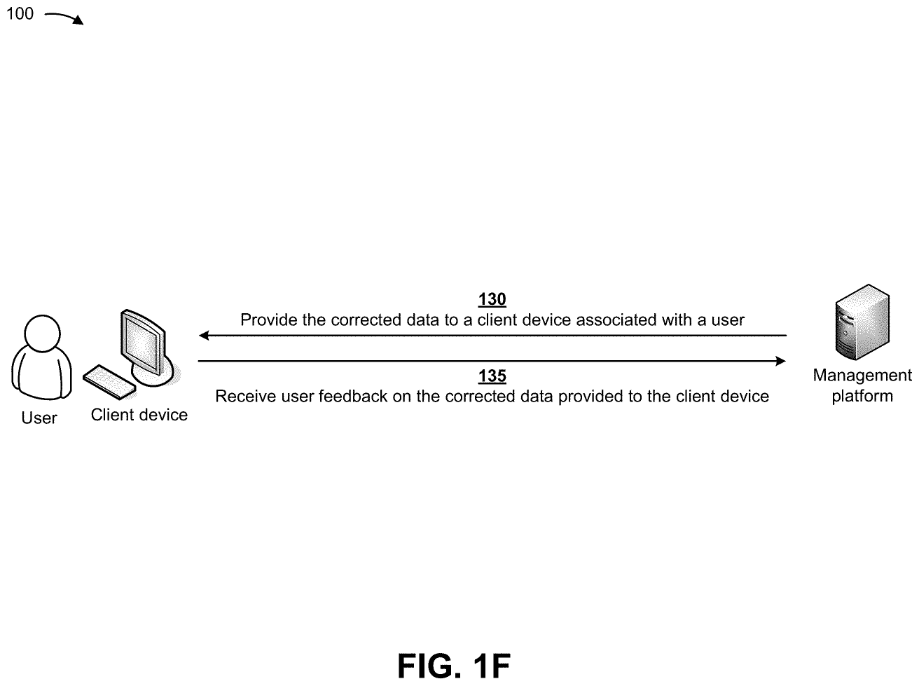

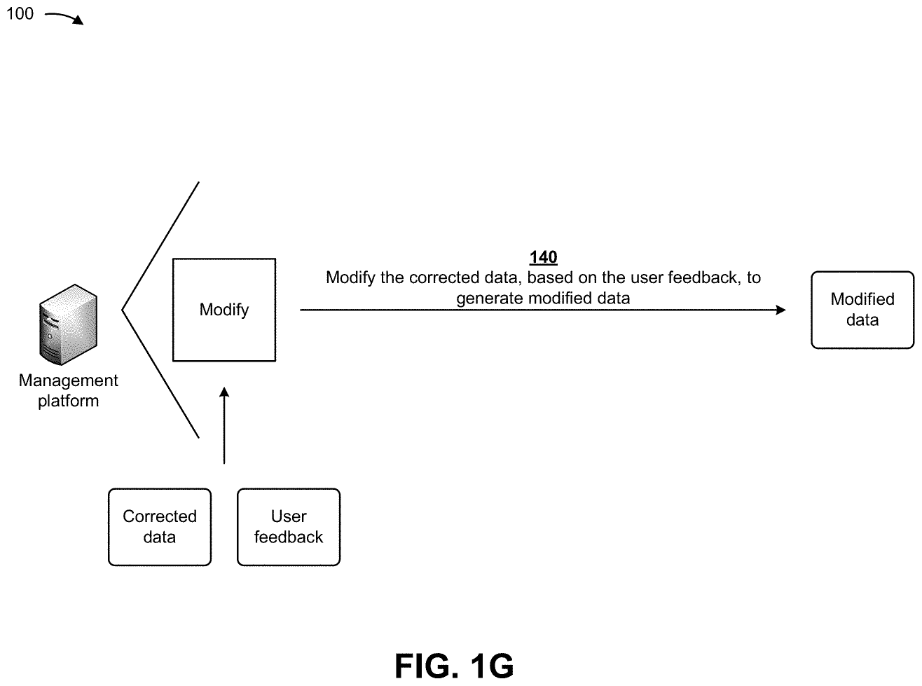

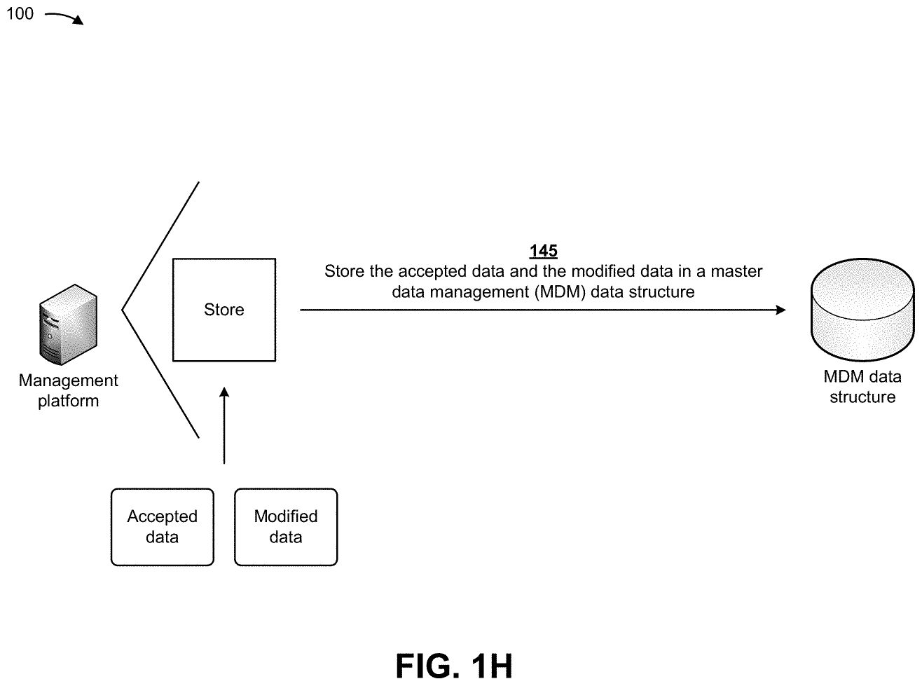

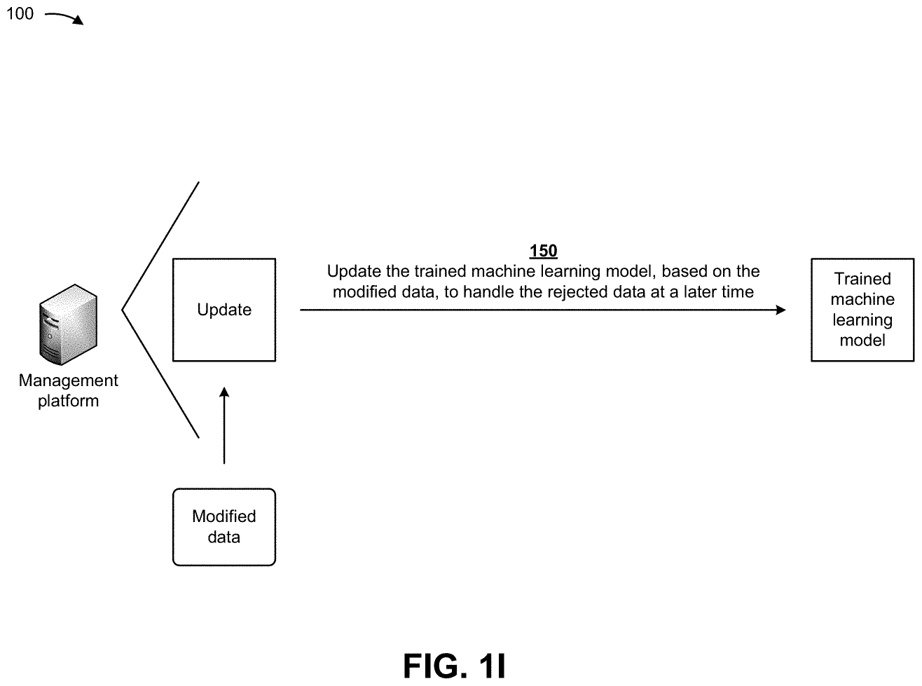

FIGS. 1A-1I are diagrams of one or more example implementations 100 described herein. As shown in FIG. 1A, server devices may be associated with a management platform. In some implementations, the server devices may be data sources that generate data associated with an entity (e.g., a company, an organization, a government agency, an enterprise, and/or the like). For example, the server devices may include server devices that enable the entity to perform daily functions, such as email functions, financial functions, manufacturing functions, research and development functions, and/or the like.

As further shown in FIG. 1A, and by reference number 105, the management platform may receive data from one or more of the multiple data sources. In some implementations, the data may include reference data (e.g., a set of permissible values), analytical data that supports decision making, data to be integrated into master data, and/or the like. In some implementations, there may be hundreds, thousands, and/or the like, of server devices that produce thousands, millions, billions, and/or the like, of data points provided in the data. In this way, the management platform may handle thousands, millions, billions, and/or the like, of data points within a period of time (e.g., daily, weekly, monthly), and thus may provide “big data” capability.

As shown in FIG. 1B, and by reference number 110, the management platform may reject a portion of the data as rejected data and may accept a remaining portion of the data as accepted data. In some implementations, the management platform may determine data to be rejected data when the data is unrecognized, unstructured, improperly formatted, from different data source forms of input, incorrectly entered, and/or the like. In some implementations, the management platform may determine data to be accepted data when the data is recognized, structured, properly formatted, from the same or similar data source forms of input, correctly entered, and/or the like. In some implementations, the management platform may utilize a data quality tool to determine the rejected data and the accepted data from the data.

As shown in FIG. 1C, and by reference number 115, the management platform may cleanse and parse the rejected data to generate parsed rejected data. In some implementations, if the rejected data can be parsed, the management platform may not perform a cleansing operation on the rejected data and may parse the rejected data to generate the parsed rejected data. If the rejected data cannot be parsed, the management platform may perform the cleansing operation on the rejected data prior to parsing the rejected data, and may parse the cleansed rejected data to generate the parsed rejected data. In some implementations, the parsed rejected data (e.g., that is or is not cleansed before parsing) may be provided as training data to a machine learning model, as described below.

In some implementations, the cleansing operation may detect and correct (or remove) corrupt or inaccurate data points from the rejected data; may identify incomplete, incorrect, inaccurate or irrelevant portions of the rejected data and may replace, modify, or delete the identified portions of the rejected data; and/or the like. In some implementations, the cleansing operation may be performed interactively with a data wrangling tool, as batch processing through scripting, and/or the like. In some implementations, the management platform may utilize a model and natural language processing techniques to parse the rejected data into components. The model may include a probabilistic model that attempts to identify the components of the rejected data. The management platform may utilize a library to train the model and improve identification of the components of the rejected data.

As shown in FIG. 1D, and by reference number 120, the management platform may train a machine learning model, with historical rejected data, to generate a trained machine learning model. In some implementations, the machine learning model may include a probabilistic model, a conditional random fields (CRF) model, and/or the like. The trained machine learning model may be utilized by the management platform to correct the rejected data and to generate corrected data. In some implementations, the historical rejected data may include data (e.g., received prior to the data described in connection with FIG. 1A) that is unrecognized, unstructured, improperly formatted, from different data source forms of input, incorrectly entered, and/or the like.

In some implementations, the management platform may train the machine learning model, with the historical rejected data, to identify corrections for the historical rejected data. For example, the management platform may separate the historical rejected data into a training set, a validation set, a test set, and/or the like. The training set may be utilized to train the machine learning model. The validation set may be utilized to validate results of the trained machine learning model. The test set may be utilized to test operation of the machine learning model.

In some implementations, the management platform may train the machine learning model using, for example, an unsupervised training procedure and based on the historical rejected data. For example, the management platform may perform dimensionality reduction to reduce the historical rejected data to a minimum feature set, thereby reducing resources (e.g., processing resources, memory resources, and/or the like) to train the machine learning model, and may apply a classification technique to the minimum feature set.

In some implementations, the management platform may use a logistic regression classification technique to determine a categorical outcome (e.g., that the historical rejected data should be corrected a particular way). Additionally, or alternatively, the management platform may use a naive Bayesian classifier technique. In this case, the management platform may perform binary recursive partitioning to split the historical rejected data into partitions and/or branches and use the partitions and/or branches to determine outcomes (e.g., that the historical rejected data should be corrected a particular way). Based on using recursive partitioning, the management platform may reduce utilization of computing resources relative to manual, linear sorting and analysis of data points, thereby enabling use of thousands, millions, or billions of data points to train the machine learning model, which may result in a more accurate model than using fewer data points.

Additionally, or alternatively, the management platform may use a support vector machine (SVM) classifier technique to generate a non-linear boundary between data points in the training set. In this case, the non-linear boundary is used to classify test data into a particular class.

Additionally, or alternatively, the management platform may train the machine learning model using a supervised training procedure that includes receiving input to the machine learning model from a subject matter expert, which may reduce an amount of time, an amount of processing resources, and/or the like to train the machine learning model relative to an unsupervised training procedure. In some implementations, the management platform may use one or more other model training techniques, such as a neural network technique, a latent semantic indexing technique, and/or the like. For example, the management platform may perform an artificial neural network processing technique (e.g., using a two-layer feedforward neural network architecture, a three-layer feedforward neural network architecture, and/or the like) to perform pattern recognition with regard to patterns of the historical rejected data. In this case, using the artificial neural network processing technique may improve an accuracy of the trained analytical models generated by the management platform by being more robust to noisy, imprecise, or incomplete data, and by enabling the management platform to detect patterns and/or trends undetectable to human analysts or systems using less complex techniques.

As shown in FIG. 1E, and by reference number 125, the management platform may process the parsed rejected data, with the trained machine learning model, to correct the parsed rejected data and to generate corrected data. In some implementations, the management platform may utilize one or more representational state transfer (REST) application programming interfaces (APIs), a simple object access protocol (SOAP) service, and/or the like to receive the parsed rejected data and to provide the parsed rejected data to the trained machine learning model. In some implementations, the trained machine learning model may match or substantially match the parsed rejected data and historical rejected data used to train the machine learning model. The trained machine learning model may identify corrections made to the matching historical rejected data and may implement such corrections for the parsed rejected data. The corrections to the parsed rejected data may generate the corrected data.

In some implementations, the management platform may determine whether the corrected data satisfies a threshold level of correctness. For example, if the trained machine learning model exactly matches the parsed rejected data and the historical rejected data, the management platform may determine that the corrected data satisfies the threshold level of correctness. Alternatively, if the trained machine learning model substantially matches the parsed rejected data and the historical rejected data, the management platform may determine that the corrected data fails to satisfy the threshold level of correctness. In some implementations, if the corrected data satisfies the threshold level of correctness, the management platform may store the corrected data in a data structure associated with the management platform, as described below, and may update the machine learning model based on the corrected data.

In some implementations, if the corrected data fails to satisfy the threshold level of correctness, the management platform may provide the corrected data to a client device associated with a user (e.g., a data manager), as shown by reference number 130 in FIG. 1F. The client device may receive the corrected data and may provide the corrected data for display to the user. The user may review the corrected data and may provide user feedback on the corrected data. For example, the user feedback may include the user approving the corrected data, making one or more changes to the corrected data, removing one or more data points from the corrected data, and/or the like.

As further shown in FIG. 1F, and by reference number 135, the management platform may receive, from the client device, user feedback on the corrected data provided to the client device. In some implementations, the management platform may store the user feedback in a data structure associated with the management platform, may utilize the user feedback to update the machine learning model, and/or the like.

As shown in FIG. 1G, and by reference number 140, the management platform may modify the corrected data, based on the user feedback, to generate modified data. For example, the management platform may utilize the user feedback to make one or more changes to the corrected data, to remove one or more data points from the corrected data, and/or the like. In some implementations, the modified data may include the corrected data with the one or more changes, the corrected data without the removed one or more data points, and/or the like.

As shown in FIG. 1H, and by reference number 145, the management platform may store the accepted data and the modified data in a master data management (MDM) data structure (e.g., a database, a table, a list, and/or the like) associated with the management platform. In some implementations, the management platform may store the accepted data in the MDM data structure when the remaining portion of the data is accepted as the accepted data (e.g., prior to determination of the corrected data and/or the modified data). In some implementations, the management platform may incrementally store the modified data in the MDM data structure in order to conserve and prevent overloading of computing resources (e.g., processing resources, memory resources, and/or the like), network resources, and/or the like.

In some implementations, the management platform may provide the accepted data and the modified data (or the corrected data) from the MDM data structure (e.g., as master data) to one or more server devices associated with an entity. For example, the management platform may provide the master data to the server devices (e.g., the data sources) described above in connection with FIG. 1A. In this way, the server devices may have access to accurate and timely master data that enables the server devices to manage services provided to the entity, to ensure that entity decisions are made based on the most accurate data, to prevent erroneous decisions based on incomplete data, and/or the like. This may conserve computing resources, network resources, and/or the like that would otherwise be wasted in identifying erroneous decisions and/or data, determining corrections for the erroneous decisions and/or data, implementing the corrections, and/or the like.

As shown in FIG. 1I, and by reference number 150, the management platform may update the trained machine learning model, based on the modified data, to handle the rejected data at a later time. For example, the management platform may utilize the modified data as training data to train the machine learning model to automatically handle the rejected data at a later time. In this way, the management platform continuously updates the machine learning model so that user feedback may become less necessary in the future.

In this way, several different stages of the process for correcting rejected data may be automated via a machine learning model, which may improve speed and efficiency of the process and conserve computing resources (e.g., processing resources, memory resources, and/or the like). Furthermore, implementations described herein use a rigorous, computerized process to perform tasks or roles that were not previously performed. For example, currently there does not exist a technique that utilizes a machine learning model to automatically correct rejected data. Further, the process for utilizing a machine learning model to automatically correct rejected data conserves resources (e.g., processing resources, memory resources, network resources, transportation resources, and/or the like) that would otherwise be wasted in repeatedly investigating, determining, and correcting the same rejected data. The process for utilizing a machine learning model to automatically correct rejected data also conserves such resources by reducing errors associated with correcting rejected data, improving data quality accuracy associated with the rejected data, delivering the rejected data more quickly for an entity, eliminating a need for a system development life cycle (SDLC) and an exchange to exchange (E2E) development cycle, and/or the like.

As indicated above, FIGS. 1A-1I are provided merely as examples. Other examples may differ from what is described with regard to FIGS. 1A-1I.

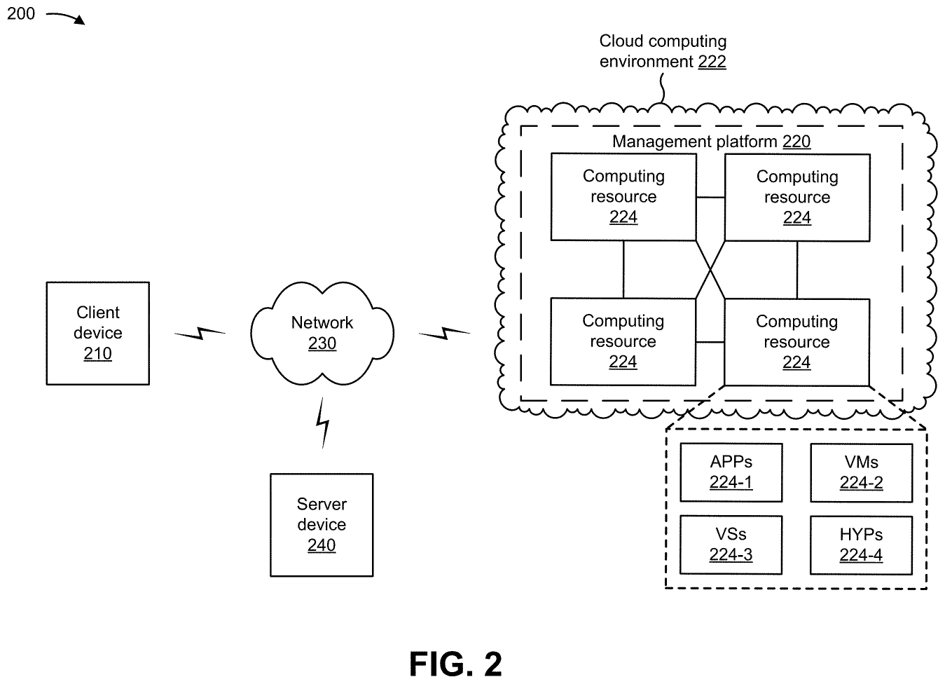

FIG. 2 is a diagram of an example environment 200 in which systems and/or methods described herein may be implemented. As shown in FIG. 2, environment 200 may include a client device 210, a management platform 220, a network 230, and a server device 240. Devices of environment 200 may interconnect via wired connections, wireless connections, or a combination of wired and wireless connections.

Client device 210 includes one or more devices capable of receiving, generating, storing, processing, and/or providing information, such as information described herein. For example, client device 210 may include a mobile phone (e.g., a smart phone, a radiotelephone, etc.), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, a head mounted display, etc.), or a similar type of device. In some implementations, client device 210 may receive information from and/or transmit information to management platform 220 and/or server device 240.

Management platform 220 includes one or more devices that utilize a machine learning model to automatically correct rejected data. In some implementations, management platform 220 may be designed to be modular such that certain software components may be swapped in or out depending on a particular need. As such, management platform 220 may be easily and/or quickly reconfigured for different uses. In some implementations, management platform 220 may receive information from and/or transmit information to one or more client devices 210 and/or server devices 240.

In some implementations, as shown, management platform 220 may be hosted in a cloud computing environment 222. Notably, while implementations described herein describe management platform 220 as being hosted in cloud computing environment 222, in some implementations, management platform 220 may not be cloud-based (i.e., may be implemented outside of a cloud computing environment) or may be partially cloud-based.

Cloud computing environment 222 includes an environment that hosts management platform 220. Cloud computing environment 222 may provide computation, software, data access, storage, etc., services that do not require end-user knowledge of a physical location and configuration of system(s) and/or device(s) that hosts management platform 220. As shown, cloud computing environment 222 may include a group of computing resources 224 (referred to collectively as “computing resources 224” and individually as “computing resource 224”).

Computing resource 224 includes one or more personal computers, workstation computers, mainframe devices, or other types of computation and/or communication devices. In some implementations, computing resource 224 may host management platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by client device 210. Application 224-1 may eliminate a need to install and execute the software applications on client device 210. For example, application 224-1 may include software associated with management platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program and may support a single process. In some implementations, virtual machine 224-2 may execute on behalf of a user (e.g., a user of client device 210 or an operator of management platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Server device 240 includes one or more devices capable of receiving, generating, storing, processing, and/or providing information, such as information described herein. For example, server device 240 may include a laptop computer, a tablet computer, a desktop computer, a group of server devices, or a similar type of device, associated with an entity as described above. In some implementations, server device 240 may receive information from and/or transmit information to client device 210 and/or management platform 220.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

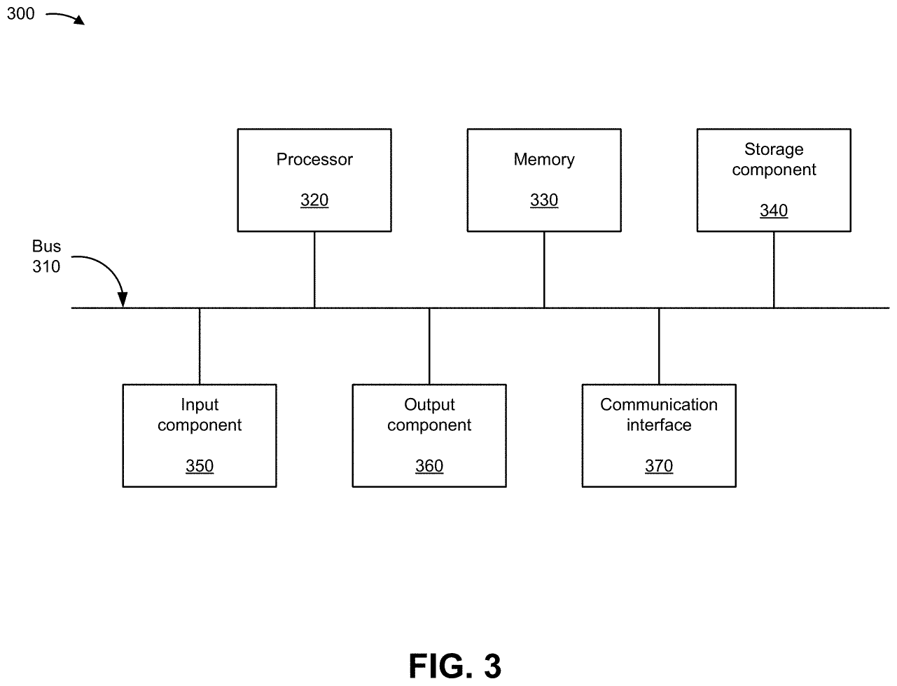

FIG. 3 is a diagram of example components of a device 300. Device 300 may correspond to client device 210, management platform 220, computing resource 224, and/or server device 240. In some implementations, client device 210, management platform 220, computing resource 224, and/or server device 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

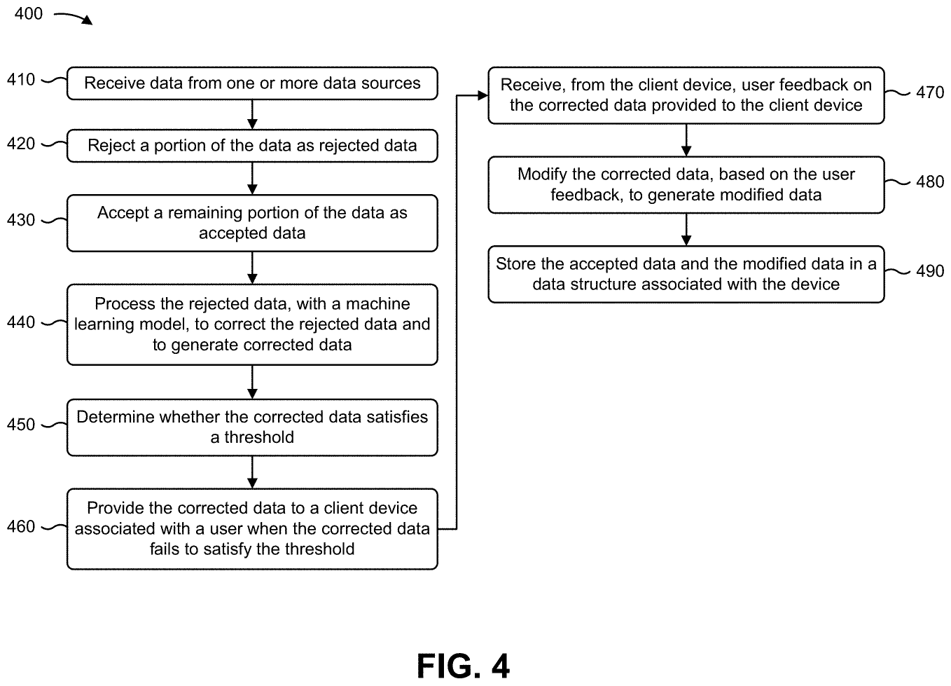

FIG. 4 is a flow chart of an example process 400 for utilizing a machine learning model to automatically correct rejected data. In some implementations, one or more process blocks of FIG. 4 may be performed by a management platform (e.g., management platform 220). In some implementations, one or more process blocks of FIG. 4 may be performed by another device or a group of devices separate from or including the management platform, such as a client device (e.g., client device 210).

As shown in FIG. 4, process 400 may include receiving data from one or more data sources (block 410). For example, the management platform (e.g., using computing resource 224, processor 320, communication interface 370, and/or the like) may receive data from one or more data sources, as described above.

As further shown in FIG. 4, process 400 may include rejecting a portion of the data as rejected data (block 420). For example, the management platform (e.g., using computing resource 224, processor 320, memory 330, and/or the like) may reject a portion of the data as rejected data, as described above.

As further shown in FIG. 4, process 400 may include accepting another portion of the data as accepted data (block 430). For example, the management platform (e.g., using computing resource 224, processor 320, storage component 340, and/or the like) may accept another portion of the data as accepted data, as described above.

As further shown in FIG. 4, process 400 may include processing the rejected data, with a machine learning model, to correct the rejected data and to generate corrected data (block 440). For example, the management platform (e.g., using computing resource 224, processor 320, memory 330, and/or the like) may process the rejected data, with a machine learning model, to correct the rejected data and to generate corrected data, as described above.

As further shown in FIG. 4, process 400 may include determining whether the corrected data satisfies a threshold (block 450). For example, the management platform (e.g., using computing resource 224, processor 320, storage component 340, and/or the like) may determine whether the corrected data satisfies a threshold, as described above.

As further shown in FIG. 4, process 400 may include providing the corrected data to a client device associated with a user when the corrected data fails to satisfy the threshold (block 460). For example, the management platform (e.g., using computing resource 224, processor 320, communication interface 370, and/or the like) may provide the corrected data to a client device associated with a user when the corrected data fails to satisfy the threshold, as described above.

As further shown in FIG. 4, process 400 may include receiving, from the client device, user feedback on the corrected data provided to the client device (block 470). For example, the management platform (e.g., using computing resource 224, processor 320, communication interface 370, and/or the like) may receive, from the client device, user feedback on the corrected data provided to the client device, as described above.

As further shown in FIG. 4, process 400 may include modifying the corrected data, based on the user feedback, to generate modified data (block 480). For example, the management platform (e.g., using computing resource 224, processor 320, memory 330, and/or the like) may modify the corrected data, based on the user feedback, to generate modified data, as described above.

As further shown in FIG. 4, process 400 may include storing the accepted data and the modified data in a data structure associated with the device (block 490). For example, the management platform (e.g., using computing resource 224, processor 320, storage component 340, and/or the like) may store the accepted data and the modified data in a data structure associated with the device, as described above.

Process 400 may include additional implementations, such as any single implementation or any combination of implementations described below and/or in connection with one or more other processes described elsewhere herein.

In some implementations, the management platform may update the machine learning model, based on the modified data, to handle the rejected data at a later time. In some implementations, the management platform may cleanse and parse the rejected data to generate clean parsed rejected data, where the clean parsed rejected data may be processed by the machine learning model.

In some implementations, the management platform may train a model, with historical rejected data, to generate the machine learning model, where the historical rejected data may be received prior to receipt of the data from the one or more data sources. In some implementations, the rejected data may include unrecognized data, unstructured data, improperly formatted data, data from different data source forms of input, incorrectly entered data, and/or the like. In some implementations, the data structure may include a master data management (MDM) data structure. In some implementations, the machine learning model may include a conditional random fields machine learning model.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

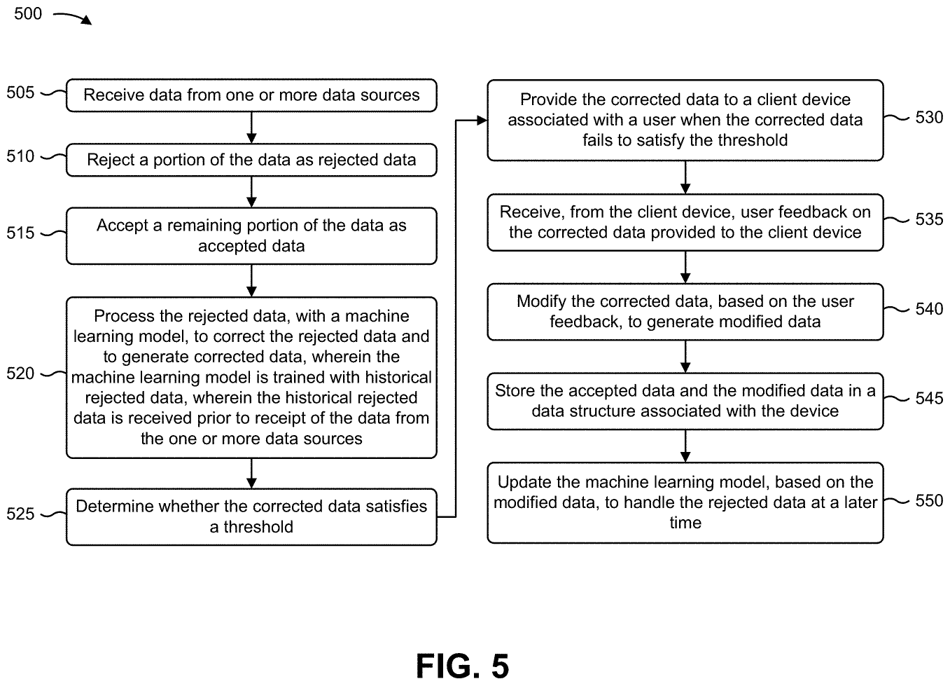

FIG. 5 is a flow chart of an example process 500 for utilizing a machine learning model to automatically correct rejected data. In some implementations, one or more process blocks of FIG. 5 may be performed by a management platform (e.g., management platform 220). In some implementations, one or more process blocks of FIG. 5 may be performed by another device or a group of devices separate from or including the management platform, such as a client device (e.g., client device 210).

As shown in FIG. 5, process 500 may include receiving data from one or more data sources (block 505). For example, the management platform (e.g., using computing resource 224, processor 320, communication interface 370, and/or the like) may receive data from one or more data sources, as described above.

As further shown in FIG. 5, process 500 may include rejecting a portion of the data as rejected data (block 510). For example, the management platform (e.g., using computing resource 224, processor 320, memory 330, and/or the like) may reject a portion of the data as rejected data, as described above.

As further shown in FIG. 5, process 500 may include accepting a remaining portion of the data as accepted data (block 515). For example, the management platform (e.g., using computing resource 224, processor 320, storage component 340, and/or the like) may accept a remaining portion of the data as accepted data, as described above.

As further shown in FIG. 5, process 500 may include processing the rejected data, with a machine learning model, to correct the rejected data and to generate corrected data, wherein the machine learning model is trained with historical rejected data, and wherein the historical rejected data is received prior to receipt of the data from the one or more data sources (block 520). For example, the management platform (e.g., using computing resource 224, processor 320, memory 330, and/or the like) may process the rejected data, with a machine learning model, to correct the rejected data and to generate corrected data, wherein the machine learning model is trained with historical rejected data, and wherein the historical rejected data is received prior to receipt of the data from the one or more data sources, as described above. In some implementations, the machine learning model may be trained with historical rejected data, and the historical rejected data may be received prior to receipt of the data from the one or more data sources.

As further shown in FIG. 5, process 500 may include determining whether the corrected data satisfies a threshold (block 525). For example, the management platform (e.g., using computing resource 224, processor 320, storage component 340, and/or the like) may determine whether the corrected data satisfies a threshold, as described above.

As further shown in FIG. 5, process 500 may include providing the corrected data to a client device associated with a user when the corrected data fails to satisfy the threshold (block 530). For example, the management platform (e.g., using computing resource 224, processor 320, communication interface 370, and/or the like) may provide the corrected data to a client device associated with a user when the corrected data fails to satisfy the threshold, as described above.

As further shown in FIG. 5, process 500 may include receiving, from the client device, user feedback on the corrected data provided to the client device (block 535). For example, the management platform (e.g., using computing resource 224, processor 320, communication interface 370, and/or the like) may receive, from the client device, user feedback on the corrected data provided to the client device, as described above.

As further shown in FIG. 5, process 500 may include modifying the corrected data, based on the user feedback, to generate modified data (block 540). For example, the management platform (e.g., using computing resource 224, processor 320, memory 330, and/or the like) may modify the corrected data, based on the user feedback, to generate modified data, as described above.

As further shown in FIG. 5, process 500 may include storing the accepted data and the modified data in a data structure associated with the device (block 545). For example, the management platform (e.g., using computing resource 224, processor 320, storage component 340, and/or the like) may store the accepted data and the modified data in a data structure associated with the device, as described above.

As further shown in FIG. 5, process 500 may include updating the machine learning model, based on the modified data, to handle the rejected data at a later time (block 550). For example, the management platform (e.g., using computing resource 224, processor 320, memory 330, and/or the like) may update the machine learning model, based on the modified data, to handle the rejected data at a later time, as described above.

Process 500 may include additional implementations, such as any single implementation or any combination of implementations described below and/or in connection with one or more other processes described elsewhere herein.

In some implementations, the management platform may store the accepted data and the corrected data in the data structure when the corrected data satisfies the threshold, and may update the machine learning model, based on the corrected data and when the corrected data satisfies the threshold, to handle the rejected data at a later time.

In some implementations, the management platform may utilize one or more representational state transfer (REST) application programming interfaces (APIs) to provide the rejected data to the machine learning model. In some implementations, the management platform may utilize a simple object access protocol (SOAP) service to provide the rejected data to the machine learning model.

In some implementations, when storing the accepted data and the modified data in the data structure, the management platform may store the accepted data in the data structure when the remaining portion of the data is accepted as the accepted data, and may incrementally store the modified data in the data structure. In some implementations, the management platform may provide the accepted data and the modified data from the data structure to one or more server devices associated with an entity. In some implementations, the data structure may include a master data management (MDM) data structure.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

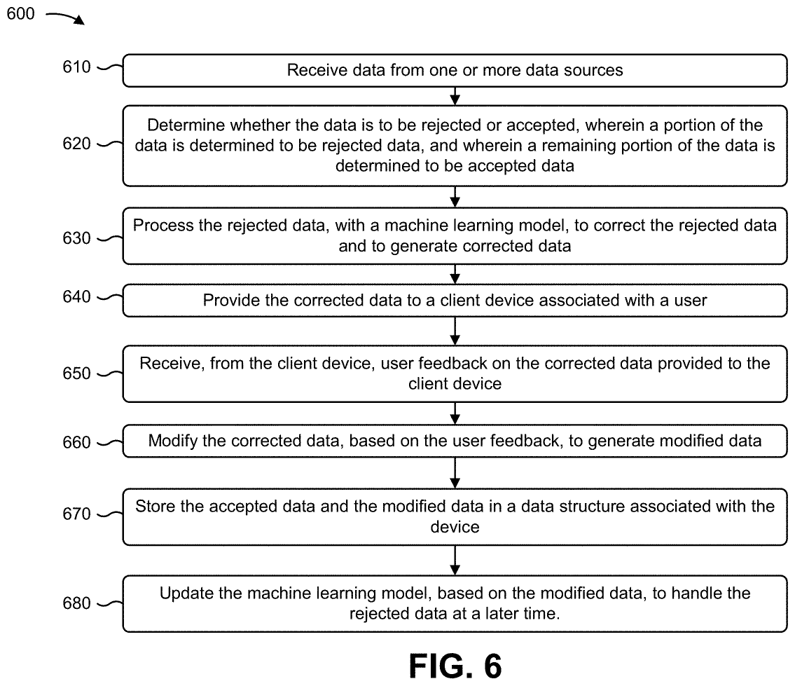

FIG. 6 is a flow chart of an example process 600 for utilizing a machine learning model to automatically correct rejected data. In some implementations, one or more process blocks of FIG. 6 may be performed by a management platform (e.g., management platform 220). In some implementations, one or more process blocks of FIG. 6 may be performed by another device or a group of devices separate from or including the management platform, such as a client device (e.g., client device 210).

As shown in FIG. 6, process 600 may include receiving data from one or more data sources (block 610). For example, the management platform (e.g., using computing resource 224, processor 320, communication interface 370, and/or the like) may receive data from one or more data sources, as described above.

As further shown in FIG. 6, process 600 may include determining whether the data is to be rejected or accepted, wherein a portion of the data is determined to be rejected data and wherein a remaining portion of the data is determined to be accepted data (block 620). For example, the management platform (e.g., using computing resource 224, processor 320, memory 330, and/or the like) may determine whether the data is to be rejected or accepted, as described above. In some implementations, a portion of the data may be determined to be rejected data, and a remaining portion of the data may be determined to be accepted data.

As further shown in FIG. 6, process 600 may include processing the rejected data, with a machine learning model, to correct the rejected data and to generate corrected data (block 630). For example, the management platform (e.g., using computing resource 224, processor 320, storage component 340, and/or the like) may process the rejected data, with a machine learning model, to correct the rejected data and to generate corrected data, as described above.

As further shown in FIG. 6, process 600 may include providing the corrected data to a client device associated with a user (block 640). For example, the management platform (e.g., using computing resource 224, processor 320, communication interface 370, and/or the like) may provide the corrected data to a client device associated with a user, as described above.

As further shown in FIG. 6, process 600 may include receiving, from the client device, user feedback on the corrected data provided to the client device (block 650). For example, the management platform (e.g., using computing resource 224, processor 320, communication interface 370, and/or the like) may receive, from the client device, user feedback on the corrected data provided to the client device, as described above.

As further shown in FIG. 6, process 600 may include modifying the corrected data, based on the user feedback, to generate modified data (block 660). For example, the management platform (e.g., using computing resource 224, processor 320, memory 330, and/or the like) may modify the corrected data, based on the user feedback, to generate modified data, as described above.

As further shown in FIG. 6, process 600 may include storing the accepted data and the modified data in a data structure associated with the device (block 670). For example, the management platform (e.g., using computing resource 224, processor 320, storage component 340, and/or the like) may store the accepted data and the modified data in a data structure associated with the device, as described above.

As further shown in FIG. 6, process 600 may include updating the machine learning model, based on the modified data, to handle the rejected data at a later time (block 680). For example, the management platform (e.g., using computing resource 224, processor 320, memory 330, and/or the like) may update the machine learning model, based on the modified data, to handle the rejected data at a later time, as described above.

Process 600 may include additional implementations, such as any single implementation or any combination of implementations described below and/or in connection with one or more other processes described elsewhere herein.

In some implementations, the management platform may parse the rejected data to generate parsed rejected data, where the parsed rejected data may be processed by the machine learning model. In some implementations, the rejected data may include unrecognized data, unstructured data, improperly formatted data, data from different data source forms of input, incorrectly entered data, and/or the like. In some implementations, the management platform may store the accepted data and the corrected data in the data structure, and may update the machine learning model, based on the corrected data, to handle the rejected data at a later time.

In some implementations, the management platform may utilize representational state transfer (REST) application programming interfaces (APIs) to provide the rejected data to the machine learning model, may utilize a simple object access protocol (SOAP) service to provide the rejected data to the machine learning model, and/or the like. In some implementations, the management platform may provide the accepted data and the modified data from the data structure to one or more server devices associated with an entity.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, data from one or more data sources;
rejecting, by the device, a portion of the data as rejected data;
accepting, by the device, another portion of the data as accepted data;
processing, by the device, the rejected data, with a machine learning model, to correct the rejected data and to generate corrected data;
determining, by the device, whether the corrected data satisfies a threshold;
providing, by the device, the corrected data to a client device associated with a user when the corrected data fails to satisfy the threshold;
receiving, by the device and from the client device, user feedback on the corrected data provided to the client device;
modifying, by the device, the corrected data, based on the user feedback, to generate modified data; and
storing, by the device, the accepted data and the modified data in a data structure associated with the device.

2. The method of claim 1, further comprising:
updating the machine learning model, based on the modified data, to handle the rejected data at a later time.

3. The method of claim 1, further comprising:
cleansing and parsing the rejected data to generate clean parsed rejected data,
wherein the clean parsed rejected data is processed by the machine learning model.

4. The method of claim 1, further comprising:
training a model, with historical rejected data, to generate the machine learning model, wherein the historical rejected data is received prior to receipt of the data from the one or more data sources.

5. The method of claim 1, wherein the rejected data includes one or more of:
unrecognized data,
unstructured data,
improperly formatted data,
data from different data source forms of input, or
incorrectly entered data.

6. The method of claim 1, wherein the data structure includes a master data management (MDM) data structure.

7. The method of claim 1, wherein the machine learning model includes a conditional random fields machine learning model.

8. A device, comprising:
one or more memories; and
one or more processors, communicatively coupled to the one or more memories, to:
receive data from one or more data sources;
reject a portion of the data as rejected data;
accept a remaining portion of the data as accepted data;
process the rejected data, with a machine learning model, to correct the rejected data and to generate corrected data,
wherein the machine learning model is trained with historical rejected data,
wherein the historical rejected data is received prior to receipt of the data from the one or more data sources;
determine whether the corrected data satisfies a threshold;
provide the corrected data to a client device associated with a user when the corrected data fails to satisfy the threshold;
receive, from the client device, user feedback on the corrected data provided to the client device;
modify the corrected data, based on the user feedback, to generate modified data;
store the accepted data and the modified data in a data structure associated with the device; and
update the machine learning model, based on the modified data, to handle the rejected data at a later time.

9. The device of claim 8, wherein the one or more processors are further to:
store the accepted data and the corrected data in the data structure when the corrected data satisfies the threshold; and
update the machine learning model, based on the corrected data and when the corrected data satisfies the threshold, to handle the rejected data at a later time.

10. The device of claim 8, wherein the one or more processors are further to:
utilize one or more representational state transfer (REST) application programming interfaces (APIs) to provide the rejected data to the machine learning model.

11. The device of claim 8, wherein the one or more processors are further to:
utilize a simple object access protocol (SOAP) service to provide the rejected data to the machine learning model.

12. The device of claim 8, wherein the one or more processors, when storing the accepted data and the modified data in the data structure, are to:
store the accepted data in the data structure when the remaining portion of the data is accepted as the accepted data; and
incrementally store the modified data in the data structure.

13. The device of claim 8, wherein the one or more processors are further to:
provide the accepted data and the modified data from the data structure to one or more server devices associated with an entity.

14. The device of claim 8, wherein the data structure includes a master data management (MDM) data structure.

15. A non-transitory computer-readable medium storing instructions, the instructions comprising:
one or more instructions that, when executed by one or more processors, cause the one or more processors to:
receive data from one or more data sources;
determine whether the data is to be rejected or accepted,
wherein a portion of the data is determined to be rejected data, and
wherein a remaining portion of the data is determined to be accepted data;
process the rejected data, with a machine learning model, to correct the rejected data and to generate corrected data;
provide the corrected data to a client device associated with a user;
receive, from the client device, user feedback on the corrected data provided to the client device;
modify the corrected data, based on the user feedback, to generate modified data;
store the accepted data and the modified data in a data structure associated with the device; and
update the machine learning model, based on the modified data, to handle the rejected data at a later time.

16. The non-transitory computer-readable medium of claim 15, wherein the instructions further comprise:
one or more instructions that, when executed by the one or more processors, cause the one or more processors to:
parse the rejected data to generate parsed rejected data,
wherein the parsed rejected data is processed by the machine learning model.

17. The non-transitory computer-readable medium of claim 15, wherein the rejected data includes one or more of:
unrecognized data,
unstructured data,
improperly formatted data,
data from different data source forms of input, or
incorrectly entered data.

18. The non-transitory computer-readable medium of claim 15, wherein the instructions further comprise:
one or more instructions that, when executed by the one or more processors, cause the one or more processors to:
store the accepted data and the corrected data in the data structure; and
update the machine learning model, based on the corrected data, to handle the rejected data at a later time.

19. The non-transitory computer-readable medium of claim 15, wherein the instructions further comprise:
one or more instructions that, when executed by the one or more processors, cause the one or more processors to one of:
utilize one or more representational state transfer (REST) application programming interfaces (APIs) to provide the rejected data to the machine learning model; or
utilize a simple object access protocol (SOAP) service to provide the rejected data to the machine learning model.

20. The non-transitory computer-readable medium of claim 15, wherein the instructions further comprise:
one or more instructions that, when executed by the one or more processors, cause the one or more processors to:
provide the accepted data and the modified data from the data structure to one or more server devices associated with an entity.
